(19) United States
(12) Patent Application Publication
(10) Pub. No.: US 2025/0226923 A1
(43) Pub. Date: Jul. 10, 2025

(54) NTN IOT HARQ DISABLING FOR HARQ BUNDLING AND MULTIPLE TB SCHEDULING

(71) Applicant: LENOVO (BEIJING) LIMITED, Beijing (CN)

(72) Inventors: Zhi YAN, Beijing (CN); Hongmei LIU, Beijing (CN); Yuantao ZHANG, Beijing (CN); Ruixiang MA, Beijing (CN); Haiming WANG, Beijing (CN)

(21) Appl. No.: 18/844,635

(22) PCT Filed: May 13, 2022
(86) PCT No.: PCT/CN2022/092629

§ 371 Date: Sep. 6, 2024

(51) Int. Cl. H04L 1/1812; H04L 1/06; H04L 5/00

(52) U.S. Cl. CPC H04L 1/1812; H04L 1/0687; H04L 5/0055

(57) ABSTRACT

Methods and apparatuses for are NTN IoT HARQ disabling for HARQ bundling and multiple TB scheduling disclosed. A UE comprises a processor; and a transceiver coupled to the processor, wherein the processor is configured to receive, via the transceiver, a control signal scheduling transport block(s), where each of the transport block(s) is associated with an HARQ process with HARQ feedback enabling or an HARQ process with HARQ feedback disabling according to an HARQ indication; and receive, via the transceiver, the transport block(s) based on the control signal.

### FIELD

The subject matter disclosed herein generally relates to wireless communications, and more particularly relates to methods and apparatuses for NTN (Non-Terrestrial Network) IoT (Internet of Things) HARQ (Hybrid Automatic Repeat request) disabling for HARQ bundling and multiple TB scheduling.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Non-Terrestrial Network (NTN), Internet of Things (IoT), Narrow Band Internet of Things (NBIoT or NB-IoT), Physical Downlink Shared Channel (PDSCH), NBIOT Physical Downlink Shared Channel (NPDSCH), Physical Downlink Control Channel (PDCCH), NBIOT Physical Downlink Control Channel (NPDCCH), machine-type communication (MTC), enhanced MTC (eMTC), MTC Physical Downlink Shared Channel (MPDSCH), MTC Physical Downlink Control Channel (MPDCCH), Downlink Control Information (DCI), Transport Block (TB), Automatic Repeat request (ARQ), Hybrid Automatic Repeat request (HARQ), Physical Uplink Control Channel (PUCCH), acknowledgement (ACK), negative acknowledgement (NACK), Radio Link Control (RLC), Frequency Division Duplex (FDD), Half-Duplex FDD (HD-FDD), bandwidth limited/coverage enhancement (BL/CE).

FIG. 1 illustrates the principal of eMTC HD-FDD data transmission in a data bundle. As shown in FIG. 1, subframes #0 to #16 are a data bundle for downlink control signal transmission, downlink data signal transmission and the corresponding feedback (ACK or NACK) transmission. Each data bundle includes downlink (DL) control channel (e.g., MPDCCH), DL data channel (e.g., PDSCH), switching gap between DL and UL, and uplink (UL) feedback channel (e.g., PUSCH or PUCCH). In FIG. 1, “M” is short for control signal (e.g. DCI) transmitted in MPDCCH; “D” is short for data signal scheduled by the control signal transmitted in PDSCH; and “U” is short for uplink feedback of the scheduled data signal transmitted in PUCCH or PUSCH. As shown in FIG. 1, in subframes #0 to #9, control signals can be transmitted in MPDCCH; in subframes #2 to #11, data signals scheduled by the control signals are transmitted in PDSCH; and in subframes #13 to #15, feedbacks of the data signals can be scheduled to be transmitted in PUCCH or PUSCH. Subframes #12 and #16 are used for uplink-downlink switching.

For a downlink data transmission process, the following steps are included. First, a control signal (such as DCI) is transmitted in a downlink control channel (e.g. MPDCCH) to schedule data signals transmitted in a downlink data channel (e.g. PDSCH). The data signals are transmitted in a subframe that is 2-subframes later than the subframe in which the control signal is completely transmitted. That is, the PDSCH scheduling delay is 2 subframes. For example, the control signal transmitted in subframe #0 schedules the data signals transmitted in subframe #2 (indicated as “+2” in FIG. 1). The data signals are transmitted in unit of TB. One TB is transmitted in one subframe. Afterwards, a feedback (ACK or NACK) of the data signals is transmitted in an uplink feedback channel (e.g. PUCCH or PUSCH) to indicate whether the corresponding data signals are correctly received (i.e. ACK) or not (i.e. NACK) at the UE side. In particular, one bit is used to indicate whether the data signals in a TB are correctly received at the UE. For example, ‘1’ represents ACK while ‘0’ represents NACK. The subframe(s) to transmit the feedbacks may be also determined by the control signal (DCI) scheduling the data signals. For example, the feedback for data signals transmitted in subframe #2 may be configured, by the control signal (transmitted in subframe #0) scheduling the data signal, e.g., to be transmitted in subframe #13. In particular, a “HARQ-ACK delay” field in the control signal may indicate that the HARQ-ACK delay is 11, that is, the feedback of the data signals is transmitted in a subframe that is 11 subframes later than the subframe in which the data signal is transmitted (i.e. 2+11=13). For ease of discussion, the data signals transmitted in a subframe (time slot) are referred to as “data signal transmitted in a subframe”.

In the above-described steps, each downlink data transmission process is associated with a process number. For example, for process #0, the control signal transmitted in subframe #0 schedules the data signal transmitted in a TB in subframe #2; and the feedback of the process #0 (i.e. for the data signal transmitted in subframe #2) is transmitted in subframe #13. The feedback of the data signal is associated with the process number so that the eNB knows with which TB (or with which subframe) the feedback is associated. The process number may also be referred to as HARQ process number. The maximal number of HARQ processes is configured by higher layer signaling. For example, the maximal number of HARQ processes is configured to 10 (e.g. HARQ processes #0 to #9) in the example of FIG. 1.

As shown in FIG. 1, control signals are transmitted, respectively, in subframes #0 to #9. Data signals are transmitted, respectively, in subframes #2 to #11. In particular, each of the scheduled data transmission subframes is 2-subframes later than the corresponding control signal transmission subframe. Therefore, control signal is transmitted in subframe #0 and the corresponding scheduled data signal is transmitted in subframe #2; control signal is transmitted in subframe #1 and the corresponding scheduled data signal is transmitted in subframe #3; . . . ; and control signal is transmitted in subframe #9 and the corresponding data signal is transmitted in subframe #11.

In case of half duplex FDD eMTC, one subframe is necessary for switching from DL to UL (or from UL to DL). Subframe #12 is used for switching from DL to UL.

Subframes #13 to #15 are used for UL transmission. In particular, subframes #13 to #15 are used to transmit feedbacks (ACK or NACK) for each of data signals transmitted in subframes #2 to #11.

Subframe #16 is used for switching from UL to DL, since a control signal will be transmitted in the next subframe (i.e. subframe #17, or subframe #0 of the next bundle, not shown in FIG. 1).

FIG. 1 shows that three subframes (subframes #13 to #15) are used for feedbacks (ACK or NACK) for data signals transmitted in ten previous subframes (subframes #2 to #11). This is achieved by HARQ bundling.

When HARQ bundling is configured, the DL scheduling information contains a DCI field “TBs in Bundle” which holds the maximal number of TBs in an HARQ bundle, e.g. 1 or 2 or 3 or 4. The HARQ bundle is feedback bundle for different HARQ processes corresponding to different TBs transmitted in different subframes. As shown in FIG. 2, U0, U1, U2 and U3, corresponding to feedbacks for TB0, TB1, TB2 and TB3 transmitted in subframes #2 to #5 (i.e. D0, D1, D2 and D3), are bundled in one HARQ bundle. That is, the feedbacks (ACK or NACK) of 4 TBs (transmitted in subframes #2 to #5) are contained in one HARQ bundle. If feedbacks of 4 TBs are contained in one HARQ bundle, the last HARQ bundle (or at least one of the HARQ bundles) may contain feedbacks of less than 4 TBs, for example, 2 TBs (i.e. U8 and U9) in FIG. 2.

As shown in FIG. 2, HARQ bundle in subframe #13 is a feedback obtained by performing logical AND operation for the feedbacks of HARQ processes #0 to #3 (i.e. data signals D0 to D3 transmitted in subframes #2 to #5 scheduled by control signals M0 to M3 transmitted in subframes #0 to #3). That is, U0 to U3 are feedbacks for D0 to D3, respectively. Each of U0 to U3 is ACK (‘1’) or NACK (‘0’). In subframe #13, one bit that is obtained by U0 AND U1 AND U2 AND U3 is transmitted. Only when all of U0 to U3 are ACK (1), U0 AND U1 AND U2 AND U3=ACK (‘1’). When any of U0 to U3 is NACK (‘0’), U0 AND U1 AND U2 AND U3=NACK (‘0’). Incidentally, HARQ bundle can be supported only in CE mode A without PDSCH repetition.

When HARQ bundling (and/or dynamic ACK timing) is configured by RRC, the HD-FDD DL scheduling information (i.e. downlink control information (DCI)) contains a DCI field “HARQ-ACK Delay” which indicates the subframes of delay between end of PDSCH transmission and start of feedback. The “HARQ-ACK Delay” field has three bits in DCI format 6-1A in LTE to indicate HARQ-ACK delays of {4-11} subframes, as shown in Table 1.

TABLE 1

| ‘HARO-ACK | HARQ-ACK delay when |
|---|---|
| delay’ field in DCI | ‘ce-HARQ-AckBundling’ is set |
| 000 | 4 |
| 001 | 5 |
| 010 | 6 |
| 011 | 7 |
| 100 | 8 |
| 101 | 9 |
| 110 | 10 |
| 111 | 11 |

For example, as shown in FIG. 2, downlink data D0 is transmitted in subframe #2 while U0 (i.e. feedback for downlink data D0) is transmitted in subframe #13. The delay between D0 and U0, which is indicated in control signal in subframe #0 (control signal M0), is 11 (indicated as “+11” in FIG. 2) (i.e. ‘HARQ-ACK delay’ field in DCI of M0 is set to “111”). On the other hand, downlink data D3 is transmitted in subframe #5 while U3 (i.e. feedback for downlink data D3) is transmitted in subframe #13. The delay between D3 and U3, which is indicated in control signal in subframe #3 (control signal M3), is 8 (indicated as “+8” in FIG. 2) (i.e. ‘HARQ-ACK delay’ field in DCI of M3 is set to “100”).

FIG. 2 also illustrates that the PDSCH scheduling delay is 2 subframes, e.g., the delay between M0 and D0 is 2 (indicated as “+2” in FIG. 2). As a whole, in a downlink data transmission process, there are two delays: a first delay refers to the delay between control signal transmitted in MPDCCH and the data signal transmitted in PDSCH scheduled by the control signal, which can be referred to as “PDSCH scheduling delay”; and a second delay refers to the delay between the data signal transmitted in PDSCH and the feedback of the data signal transmitted in PUCCH or PUSCH, which can be referred to as “HARQ-ACK delay”. Traditionally, the PDSCH scheduling delay is always 2; and the HARQ-ACK delay can be configured by a 3-bit ‘HARQ-ACK delay’ field in the control signal, as shown in Table 1. In addition, UE is configured with HARQ ACK bundling by higher layer parameter ce-HARQ-AckBundling.

FIG. 3 shows an example to achieve transmission of data signals in the first two subframes of the data bundle. In the example of FIG. 3, the maximal number of HARQ processes is extended to 14 (i.e. there can be 14 processes). The control signals in subframes #10 and #11 (M10 and M11) schedule data signals in subframes #17 and #18 (D10 and D11), respectively, e.g., by using new HARQ process numbers #10 and #11. In subframes #27 and #28, new HARQ process numbers #12 and #13 are used by control signals (M12 and M13) to schedule data signals transmitted in subframes #34 and #35 (D12 and D13). The HARQ process numbers #10 and #11 cannot be re-used in subframes #27 and #28 because the feedbacks (ACK or NACK) for the HARQ process numbers #10 and #11 (U10 and U11) are received in subframes #30 and #31, respectively, i.e. they have not been received in subframes #27 and #28.

The increase of the maximal number of HARQ processes from 10 to 14 does not require an increase of the DCI field to indicate the HARQ process mumber. This is due to the fact that both 10 and 14 HARQ process numbers can be represented by a 4-bits field in DCI.

When the maximal number of HARQ processes is extended to 14 to support transmission of data signals in the first two subframes of the data bundle, the possible values for “PDSCH scheduling delay”, and the possible values for the “HARQ-ACK delay” need to be considered.

As shown in FIG. 1 or 2, when no data signals are transmitted in the first two subframes of the data bundle, the PDSCH scheduling delay is always 2. However, when data signals are transmitted in the first two subframes of the data bundle as shown in FIG. 3, the PDSCH scheduling delay may be 2 (e.g. for legacy HARQ process numbers #0 to #9) or 7 (e.g. for new HARQ process numbers #10 to #13). In particular, the control signals in subframes #10 and #11 schedule the data signals transmitted in subframes #17 and #18 by using HARQ process numbers #10 and #11, in which the PDSCH scheduling delay is 7. For example, FIG. 3 shows “+7” which means that the data signal D10 scheduled by control signal M10 in subframe #10 will be transmitted in subframe #17 (10+7=17). The control signals M12 and M13 in subframes #27 and #28 schedule data signals D12 and D13 transmitted in subframes #34 and #35 by using HARQ process numbers #12 and #13, in which the PDSCH scheduling delay is also 7 (34-27, or 35-28). On the other hand, the control signals M0 to M9 in subframes #0 to #9 schedule data signals D0 to D9 transmitted in subframes #2 to #11 by using HARQ process numbers #0 to #9, in which the PDSCH scheduling delay is 2. The control signals M0 to M9 in subframes #17 to #26 schedule data signals D0 to D9 transmitted in subframes #19 to #28 by re-using HARQ process numbers #0 to #9, in which the PDSCH scheduling delay is also 2. For example, FIG. 3 shows “+2” which means that the data signal D0 scheduled by control signal M0 in subframe #0 will be transmitted in subframe #2 (0+2=2).

In addition, the HARQ-ACK delays of {4-11} subframes are not applicable when the maximal number of HARQ processes is extended to 14, since the HARQ-ACK delay for some data signals (e.g. D10) is at least 13 (if the feedback U10 is transmitted in subframe #30) as can be seen from FIG. 3.

Therefore, a new range ‘Range1’ is defined for the situation that 14 HARQ process numbers are supported, as shown in Table 2. The previous range of HARQ-ACK delays when ‘ce-HARQ-AckBundling’ is set is named as ‘Range2’.

TABLE 2

| | HARQ-ACK | HARQ-ACK delay when ‘ce- |
|---|---|---|
| HARQ-ACK | delay when ‘ce- | SchedulingEnhancement’ |
| delay′ field | SchedulingEnhancement’ | set to ‘range2” or ‘ce-HARQ- |
| in DCI | set to ‘range1’ | AckBundling’ is set |
| 000 | 4 | 4 |
| 001 | 5 | 5 |
| 010 | 7 | 6 |
| 011 | 9 | 7 |
| 100 | 11 | 8 |
| 101 | 13 | 9 |
| 110 | 15 | 10 |
| 111 | 17 | 11 |

As can be seen from Table 2, a new column is added to list the HARQ-ACK delays corresponding to each ‘HARQ-ACK delay’ field in DCI. In particular, in ‘Range1’, values 6, 8 and 10 are removed while 13, 15 and 17 are added. So, the new range ‘Range1’ is {4, 5, 7, 9, 11, 13, 15, 17}.

As a whole, HARQ bundle is supported only in CE mode A without PDSCH repetition. When bundling and/or dynamic ACK timing are configured by RRC, the HD-FDD DL Grant contains the DCI field “HARQ-ACK Delay” which indicates the BL/CE subframes of delay between end of PDSCH and start of ACK/NACK. The “HARQ-ACK Delay” field contains a value of 3-bits indicating one of two ranges as indicated in Table 2. When HARQ bundling is configured, the HD-FDD DL Grant contains the DCI field “TBs in Bundle” which holds the maximum number of TBs in an HARQ bundle, where the candidate maximum number of TBs in one HARQ bundle can be 1 or 2 or 3 or 4 (e.g. in each of FIGS. 2 and 3, the maximum number of TBs in the HARQ bundle is 4). A “Bundling on/off” field contained in DCI indicates bundling is on or off (e.g. ‘0’ for bundling off and ‘1’ for bundling on). If “Bundling on/off” field=1, then, the “MPDCCH repeat” field is re-purposed for the “TBs in Bundle” Field.

As mentioned earlier, when the first two subframes can be scheduled (e.g. subframes 0 and 1 of each data bundle), the scheduling delay is not limited to 2 subframes, but can be 7 subframes as well. Considering that there may be unavailable subframes, the scheduling delay between DCI and the corresponding PDSCH is indicated by DCI format 6-1A according to Table 3.

TABLE 3

| Option | Description |
|---|---|
| 0 | 2 BL/CE DL subframes |
| 1 | 1 BL/CE DL subframe + 1 subframe + 3 BL/CE UL |
| | subframes + 1 subframe + 1 BL/CE DL subframe |
| 2 | 1 subframe + 3 BL/CE UL subframes + 1 subframe + |
| | 2 BL/CE DL subframes |

For example, in FIG. 3, the scheduling delay of DCI (M10) is Option 1:1 BL/CE DL subframe (subframe #11)+1 subframe (subframe #12)+3 BL/CE UL subframes (subframes #13, 14 and 15)+1 subframe (subframe #16)+1 BL/CE DL subframe (subframe #17). The scheduling delay of DCI (M11) is Option 2:1 subframe (subframe #12)+3 BL/CE UL subframes (subframes #13, 14 and 15)+1 subframe (subframe #16)+2 BL/CE DL subframes (subframes #17 and 18).

Table 2 shows that the delay of PDSCH and corresponding HARQ can range from 4 to 17 (Option A). If unavailable subframes are considered, the delay of PDSCH and corresponding HARQ can have the format of (Option B): (y) BL/CE DL subframes+1 subframe+(z) BL/CE UL subframes, where y ranges from 0 to 11 and z ranges from 1 to 3.

As a whole, the maximal PDSCH number restriction in a bundle circle (i.e. data bundle) is limited by the maximal available HARQ mumber. If the UE has received W PDSCH transmissions (e.g. W=12 (i.e. D10, D11 and D0 to D9 in subframes #17 to #28 in FIG. 3)) before subframe n (e.g. subframe #29, i.e. n=29), and if the UE is expected to transmit HARQ-ACK for the W PDSCH transmissions in subframes {n₁, . . . , n_{L}}, nᵢ≥n (e.g. n₁=30, n₂=31, and n₃=32), the UE is not expected to receive a new PDSCH transmission in subframe n (e.g. subframe #29, i.e. n=29), where W=10 if higher layer parameter ce-pdsch-tenProcesses-config is set to ‘On’, W=12 if higher layer parameter ce-PDSCH-14HARQ-Config is configured, and W=8 otherwise.

The maximal feedback uplink subframe number restriction in a bundle is limited by maximal bundle size of 4. If the UE is expected to transmit HARQ-ACK for the PDSCH transmissions received before subframe n (e.g. subframe #29) in subframes {n₁, n₂ . . . n₃}, nᵢ≥n (e.g. n₁=30, n₂=31, and n₃=32), the UE is not expected to receive a new PDSCH transmission in subframe n (e.g. subframe #29, i.e. n=29) for which the HARQ-ACK is to be transmitted in subframe n₄∉{n₁, n₂ . . . n₃}.

A brief description of MPDSCH transmission with multiple TB scheduling is described as follows with reference to FIG. 3. A control signal (e.g. DCI) is transmitted in MPDCCH at for example subframe #0 (SF #0) scheduling multiple TBs (e.g. 8 TBs) transmitted in PDSCH, where each TB (each of D0 to D7) is transmitted in a separate subframe (i.e. from subframe #2 to subframe #9, suppose that the scheduling delay, which means the delay from the reception of the DCI (e.g. M0) to the reception of the first TB (e.g. D0), is 2 subframes). Each scheduled TB is associated with a separate HARQ process number (e.g. from HARQ process #0 to HARQ process #7). That is, D0 is associated with HARQ process #0; D1 is associated with HARQ process #1, . . . . For each TB (each of D0 to D7), an HARQ feedback (each of U0 to U7) is transmitted in PUCCH to indicate whether the PDSCH transmission in the TB is correctly received by the UE. As shown in FIG. 1, each of U0 to U7 indicates whether each of D0 to D7 is correctly received by the UE. U0 is associated with D0 because they are associated with the same HARQ process number (e.g. HARQ process #0).

The subframe at which the HARQ feedback is transmitted is determined as: for the PUCCH for corresponding TB_{b} starting in subframe s_{b}, s₀=n₀+4, s_{b}=max {n_{b}+4, s_{b-1}+N_{b-1}}, b+0, ng is the last subframe in which the PDSCH containing TB b is transmitted, No denotes the number of consecutive subframes including non-BL/CE subframes where the PUCCH with HARQ-ACK for TB b is transmitted. As shown in FIG. 3, the HARQ feedbacks (U0 to U7) for the 8 PDSCH transmissions (D0 to D7) are transmitted in subframe #6 to subframe #13, respectively, in which s_{b}=n_{b}+4, b=0 to 7.

Different number of HARQ processes is supported in eMTC and NBIoT. For eMTC CE Mode A, 8 HARQ processes are supported. So, there are 8 HARQ process numbers (i.e. HARQ processes #0 to #7) in eMTC CE Mode A. For eMTC CE Mode B, 2 HARQ processes are supported; or 4 HARQ processes are supported if multiple TB scheduling is configured. For NBIoT, 2 HARQ processes (if configured) are supported.

3GPP has defined two types of HARQ Codebook.

Type 1 HARQ Codebook is fixed size codebook provided by the gNB via RRC signaling. It means that Type 1 HARQ Codebook is configured semi-statically. For Type 1 HARQ Codebook in NR NTN, the UE will consistently report NACK for the TB associated with an HARQ process configured with HARQ feedback disabling regardless of decoding results of corresponding PDSCH.

Type 2 HARQ Codebook has dynamic size according to resource allocation. It means that Type 2 HARQ Codebook is configured dynamically. For Type 2 HARQ Codebook in NTN, only HARQ-ACKs of TBs associated with HARQ processes configured with HARQ feedback disabling are included, so that the codebook size can be reduced.

For multiple TB scheduling such as illustrated in FIG. 3, if TB bundle is supported, the UE shall generate M HARQ-ACK bits by performing a logical AND operation of HARQ-ACKs across all TBs in each TB bundle A_{b} where b=1, . . . , M. The set of TBs that belong to TB bundle A_{b} and the number of TB bundles M are given by Table 4.

TABLE 4

| DCI field | | | | | |
|---|---|---|---|---|---|
| ‘Multi-TB | | | | | |
| HARQ-ACK | | | | | |
| bundling size’ | N_{TB} = 1 | N_{TB} = 2 | N_{TB} = 4 | N_{TB} = 6 | N_{TB} = 8 |
| 00 | A₁ = {TB₀} | A₁ = {TB₀} | A₁ = {TB₀} | A₁ = {TB₀} | A₁ = {TB₀} |
| | | A₂ = {TB₁} | A₂ = {TB₁} | A₂ = {TB₁} | A₂ = {TB₁} |
| | | | A₃ = {TB₂} | A₃ = {TB₂} | A₃ = {TB₂} |
| | | | A₄ = {TB₃} | A₄ = {TB₃} | A₄ = {TB₃} |
| | | | | A₅ = {TB₄} | A₅ = {TB₄} |
| | | | | A₆ = {TB₅} | A₆ = {TB₅} |
| | | | | | A₇ = {TB₆} |
| | | | | | A₈ = {TB₇} |
| 01 | — | A₁ = {TB₀, TB₁} | A₁ = {TB₀, TB₁} | A₁ = {TB₀, TB₁} | A₁ = {TB₀, TB₁} |
| | | | A₂ = {TB₂, TB₃} | A₂ = {TB₂, TB₃} | A₂ = {TB₂, TB₃} |
| | | | | A₃ = {TB₄, TB₅} | A₃ = {TB₄, TB₅} |
| | | | | | A₄ = {TB₆, TB₇} |
| 10 | — | — | A₁ = {TB₀, TB₁} | A₁ = {TB₀, TB₁, TB₂} | A₁ = {TB₀, TB₁, TB₂} |
| | | | A₂ = {TB₂} | A₂ = {TB₃, TB₄, TB₅} | A₂ = {TB₃, TB₄, TB₅} |
| | | | A₃ = {TB₃} | | A₃ = {TB₆, TB₇} |
| 11 | — | — | A₁ = {TB₀, TB₁, TB₂, TB₃} | A₁ = {TB₀, TB₁, TB₂, TB₃} | A₁ = {TB₀, TB₁, TB₂, TB₃} |
| | | | | A₂ = {TB₄, TB₅} | A₂ = {TB₄, TB₅, TB₆, TB₇} |

The value of N_{TB} is the number of scheduled TBs determined in the corresponding DCI. For example, N_{TB} is 8 in FIG. 4.

For each TB bundle A_{b}, one HARQ-ACK bit is used for the feedback (ACK or NACK) of the TB bundle A_{b}. For example, ‘1’ represents ACK while ‘0’ represents NACK. If all TBs belonging to TB bundle A_{b} are correctly received by the UE, the HARQ-ACK bit used for the feedback of TB bundle A_{b} is ACK (‘1’), while if any of the TBs belonging to TB bundle A_{b} is not correctly received by the UE, the HARQ-ACK bit used for the feedback of TB bundle A_{b} is NACK (‘0’). In particular, if a TB is correctly received by the UE, the HARQ-ACK of the TB is ACK (‘1’); while if a TB is not correctly received by the UE, the HARQ-ACK of the TB is NACK (‘0’). So, the HARQ-ACK bit used for the feedback of TB bundle A_{b} can be determined by a logical AND operation of the HARQ-ACK of each TB belonging to the TB bundle A_{b}.

For example, if N_{TB} is 8 and the DCI field ‘Multi-TB HARQ-ACK bundling size’ is ‘10’, then there are three TB bundles A₁={TB₀, TB₁, TB₂}, A₂={TB₃, TB₄, TB₅} and A₃={TB₆, TB₇} according to Table 1. For each TB bundle (e.g. A₁), the feedback (i.e. HARQ-ACK bit) of TB bundle A₁ is determined by the feedback of each TB (e.g. TB₀, TB₁, TB₂) belonging to the TB bundle A₁. That is, the HARQ-ACK bit used for the feedback of TB bundle A₁ can be determined by a logical AND operation of the HARQ-ACK of each TB (e.g. TB₀, TB₁, TB₂) belonging to the TB bundle A₁. It means that, only when all HARQ-ACKs of TB₀, TB₁ and TB₂ are ACK (‘1’), the HARQ-ACK bit used for the feedback of TB bundle A₁ is ACK (‘1’), while when any HARQ-ACK of TB₀, TB₁ and TB₂ is NACK (′0″), the HARQ-ACK bit used for the feedback of TB bundle A₁ is NACK (‘0’).

Disabling of the HARQ feedback has been supported in NR NTN. In particular, enabling and disabling on HARQ feedback for downlink transmission (e.g. PDSCH transmission) can be at least configurable per HARQ process via UE specific RRC signalling. For example, UE can be configured by RRC parameter to enable or disable the HARQ feedback per HARQ process (i.e. per HARQ process number) via bitmap manner. As shown in FIG. 5, suppose that there are 8 HARQ processes (e.g. with HARQ process numbers #0 to #7), a bitmap with 8 bits can indicate HARQ feedback disabling or enabling of the 8 HARQ processes. For example, 0 indicates HARQ feedback disabling and 1 indicates HARQ feedback enabling.

When HARQ feedback disabling is configured for an HARQ process number, no explicit UL feedback for DL transmission acknowledges a successful transmission of a TB associated with an HARQ process having the HARQ process number. It means that the HARQ process number can be reused for a new DL transmission without waiting for the HARQ feedback. This can avoid HARQ stalling and consequently avoid throughput degradation. Correspondingly, retransmission at RLC layer (i.e. RLC ARQ) may be required to meet reliability requirements. Typically, ARQ re-transmissions in RLC layer can have high latency, which might be acceptable to IoT services (e.g. eMTC and NBIoT) since IoT services are generally delay tolerant.

In NTN, to compensate the round trip distance from the UE and base unit (e.g. gNB or eNB) due to long receiver and transmitter distance (RTD) in NTN in which satellite is located between the receiver and the transmitter, an additional delay offset K_{offset} is introduced. It means that the “HARQ-ACK delay” will be added by the additional delay offset K_{offset}. The additional delay offset K_{offset} can be configured in SIB or RRC signaling. If the UE has its location information and the earth orbit and ephemeris information, the UE can calculate the round trip delay between the base unit and the UE by itself. The earth orbit and ephemeris information indicate the position where the satellite is. In other words, the additional delay offset K_{offset} can be alternatively determined by the UE itself. The value of the additional delay offset K_{offset} may be determined by types of satellites. For example, if the eNB is on LEO, K_{offset} can be tens of milliseconds, while if the eNB is on GEO, K_{offset} can be hundreds of milliseconds.

For IoT NTN HARQ bundling with HARQ feedback disabling (e.g. with reference to FIGS. 2 and 3), if a TB is associated with an HARQ process configured with HARQ feedback disabling, it is unknown how the HARQ bundle is obtained. For example, the HARQ bundle in subframe #13 in FIG. 12 is a feedback obtained by performing logical AND operation for the feedbacks of HARQ processes #0 to #3, i.e. U0 AND U1 AND U2 AND U3. If each of U2 and U3 is associated with an HARQ process configured with HARQ feedback disabling (which means that U2 and U3 are unnecessary) while only U0 and U1 are associated with HARQ process configured with HARQ feedback enabling, it is how the HARQ bundle for U0 to U3 is obtained.

Similarly, for multiple TB scheduling (e.g. with reference to FIG. 4), if a TB is associated with an HARQ process configured with HARQ feedback disabling, it is unknown how the feedback of a TB bundle is obtained if some of TBs in the TB bundle are associated with HARQ process configured with HARQ feedback enabling and some of TBs in the TB bundle are associated with HARQ process configured with HARQ feedback disabling.

This invention targets solving the above problems in NIN IoT HARQ disabling for HARQ bundling and multiple TB scheduling.

### BRIEF SUMMARY

Methods and apparatuses for NIN IoT HARQ disabling for HARQ bundling and multiple TB scheduling are disclosed.

In one embodiment, a UE comprises a processor; and a transceiver coupled to the processor, wherein the processor is configured to receive, via the transceiver, a control signal scheduling transport block(s), where each of the transport block(s) is associated with an HARQ process with HARQ feedback enabling or an HARQ process with HARQ feedback disabling according to an HARQ indication; and receive, via the transceiver, the transport block(s) based on the control signal.

In some embodiment, the HARQ indication is configured by higher layer parameter or indicated by the control signal.

In some embodiment, the processor is further configured to generate, a HARQ-ACK bit by performing logical AND operation of HARQ-ACKs across a first number of time slots, wherein, each of the first number of time slots provides a transport block associated with an HARQ process with HARQ feedback enabling; and transmit, via the transceiver, the HARQ-ACK bit in a first time slot, wherein, the first time slot is the HARQ-ACK feedback time slot for the transport block in each of first number of time slot.

In some embodiment, the processor is further configured to after having received a second number of transport blocks before a second time slot, transmit, via the transceiver, feedback for the second number of transport blocks no earlier than the second time slot, and not expected to receive new transport block in the second time slot. The second number may be determined by the number of HARQ processes with HARQ feedback enabling indicated by the HARQ indication. Alternatively, the second number may be determined by a minimal value of the number of HARQ processes with HARQ feedback enabling indicated by the HARQ indication and a fixed value.

In some embodiment, the processor is further configured to: after having received transport blocks before a third time slot, transmit, via the transceiver, feedback for the received transport blocks within a time slot set, wherein, the time slot set includes a third number of time slots determined by at least one of the number of HARQ processes with HARQ feedback enabling and a maximal bundle size, and each time slot in the time slot set is not earlier than the third time slot, and not expected to receive new transport block in the third time slot, the feedback for which is in a time slot not within time slot set. A scheduling delay between the control signal and the transmission of the transport block may be determined by the third number.

In some embodiment, the control signal schedules multiple transport blocks, and the processor is further configured to extract, from the multiple transport blocks, a first set of transport blocks with a fourth number of transport blocks, and each transport block of the first set is associated with an HARQ process number with HARQ feedback enabling. The processor may be further configured to: divide the first set of transport blocks into TB bundles according to the control signal and the fourth mumber; generate a HARQ-ACK bit for each TB bundle by performing logical AND operation of HARQ-ACK(s) of TB(s) included in each TB bundle; and transmit, via the transceiver, the generated HARQ-ACK bit(s) for the first set of transport blocks.

In one embodiment, a method at a UE comprises receiving a control signal scheduling transport block(s), where each of the transport block(s) is associated with an HARQ process with HARQ feedback enabling or an HARQ process with HARQ feedback disabling according to an HARQ indication; and receiving the transport block(s) based on the control signal.

In another embodiment, a base unit comprises a processor; and a transceiver coupled to the processor, wherein the processor is configured to transmit, via the transceiver, a control signal scheduling transport block(s), where each of the transport block(s) is associated with an HARQ process with HARQ feedback enabling or an HARQ process with HARQ feedback disabling according to an HARQ indication; and transmit, via the transceiver, the transport block(s) based on the control signal.

In some embodiment, the HARQ indication is configured by higher layer parameter or indicated by the control signal.

In some embodiment, the processor is further configured to: receive, via the transceiver, a HARQ-ACK bit in a first time slot, wherein the HARQ-ACK bit is generated by performing logical AND operation of HARQ-ACKs across a first number of time slots, wherein, each of the first number of time slots provides a transport block associated with an HARQ process with HARQ feedback enabling, and the first time slot is the HARQ-ACK feedback time slot for the transport block in each of first number of time slot.

In some embodiment, the processor is further configured to: after having transmitted a second number of transport blocks before a second time slot, receive, via the transceiver, feedback for the second number of transport blocks no earlier than the second time slot. The second number may be determined by the number of HARQ processes with HARQ feedback enabling indicated by the HARQ indication. Alternatively, the second number may be determined by a minimal value of the number of HARQ processes with HARQ feedback enabling indicated by the HARQ indication and a fixed value.

In some embodiment, the processor is further configured to: after having transmitted transport blocks before a third time slot, receive, via the transceiver, feedback for the received transport blocks within a time slot set, wherein, the time slot set includes a third number of time slots determined by at least one of the number of HARQ processes with HARQ feedback enabling and a maximal bundle size, and each time slot in the time slot set is not earlier than the third time slot. A scheduling delay between the control signal and the transmission of the transport block is determined by the third number.

In some embodiment, the control signal schedules multiple transport blocks. The processor may be further configured to receive, via the transceiver, HARQ-ACK bit(s) for a first set of transport blocks, wherein, the first set of transport blocks are extracted from the multiple transport blocks and have a fourth number of transport blocks, each transport block of the first set is associated with an HARQ process number with HARQ feedback enabling, the first set of transport blocks are divided into TB bundles according to the control signal and the fourth number, a HARQ-ACK bit for each TB bundle is generated by performing logical AND operation of HARQ-ACK(s) of TB(s) included in each TB bundle.

In yet another embodiment, a method at a base unit comprises transmitting a control signal scheduling transport block(s), where each of the transport block(s) is associated with an HARQ process with HARQ feedback enabling or an HARQ process with HARQ feedback disabling according to an HARQ indication; transmitting the transport block(s) based on the control signal.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 is a schematic diagram illustrating a prior art downlink data transmission;

FIG. 2 is a schematic diagram illustrating a HARQ bundling;

FIG. 3 is a schematic diagram illustrating an example of downlink data transmission supporting fourteen (14) process numbers;

FIG. 4 illustrates PDSCH transmission with multiple TB scheduling;

FIG. 5 illustrates NR NTN HARQ feedback disabling indication:

FIG. 6 illustrates an example of the first embodiment;

FIG. 7 illustrates an example of the second embodiment

FIG. 8 illustrates another example of the second embodiment;

FIG. 9 illustrates an example of the third embodiment;

FIG. 10 is a schematic flow chart diagram illustrating an embodiment of a method;

FIG. 11 is a schematic flow chart diagram illustrating another embodiment of a method; and

FIG. 12 is a schematic block diagram illustrating apparatuses according to one embodiment.

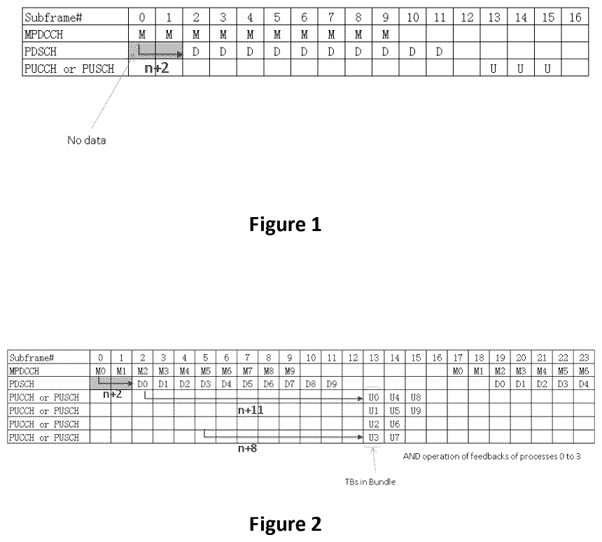

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

According to a first embodiment, for IoT NIN HARQ bundling with HARQ feedback disabling, ACK (‘1’) is assumed for any TB associated with an HARQ process configured with HARQ feedback disabling in the logical AND operation.

According to the first embodiment, the feedback of the HARQ bundle will be determined in the same manner as the prior art, i.e. obtained by performing logical AND operation for the feedbacks of HARQ processes (including HARQ process(es) configured with HARQ feedback enabling and HARQ process(es) configured with HARQ feedback disabling). Since ACK (‘1’) is assumed for any TB associated with an HARQ process configured with HARQ feedback disabling in the logical AND operation, the feedback of the HARQ bundle will be determined according to the TB(s) each of which is associated with an HARQ process configured with HARQ feedback enabling.

FIG. 6 illustrates an example of the first embodiment. In the example of FIG. 6, each of D0 and D1 is associated with an HARQ process configured with HARQ feedback enabling, and each of D2 to D9 is associated with an HARQ process configured with HARQ feedback disabling. So, according to the first embodiment, each of U2 to U9 (i.e. the feedbacks of D2 to D9) is assumed as ACK (‘1’) in the logical AND operation. Accordingly, the feedback (i.e. HARQ-ACK) of the HARQ bundle of U0, U1, U2 and U3 is U0 AND U1 AND U2 AND U3=U0 AND U1 AND ACK (‘1’) AND ACK (‘1’)=U0 AND U1. It means that only when all of U0 and U1 are ACK (‘1’), the feedback (i.e. HARQ-ACK) of the HARQ bundle of U0, U1, U2 and U3 is ACK (‘1’); and when any of U0 and U1 is NACK (‘0’), the feedback (i.e. HARQ-ACK) of the HARQ bundle of U0, U1, U2 and U3 is NACK (‘0’). It means that the feedback (i.e. HARQ-ACK) of the HARQ bundle of U0, U1, U2 and U3 is U0 AND U1 AND U2 AND U3 (by performing logical AND operation for the feedbacks of HARQ processes #0 to #3), while since U0 and U1 are ACK (‘1’), the result of U0 AND U1 AND U2 AND U3 is only determined by the feedbacks of U2 and U3.

For HARQ bundle of U4, U5, U6 and U7, since each of U4, U5, U6 and U7 is assumed as ACK (‘1’), the feedback (i.e. HARQ-ACK) of the HARQ bundle of U4, U5, U6 and U7 is ACK (‘1’). However, the HARQ bundle of U4, U5, U6 and U7 only includes TBs (i.e. D4, D5, D6 and D7) each of which is associated with an HARQ process configured as HARQ feedback disabling. So, the feedback of the HARQ bundle of U4, U5, U6 and U7 is of no use. Similarly, the feedback for the HARQ bundle of U8 and U9 is of no use.

Incidentally, although not shown in FIG. 6, the additional delay offset K_{offset} will be added to the “HARQ-ACK delay” to compensate long receiver and transmitter distance (RTD) in NTN. In addition, if all of the following description, for ease of discussion, the additional delay offset K_{offset} is not shown or assuming K_{offset} is 0 for simplicity.

In the first embodiment, the feedback of each HARQ bundle only including TBs each of which is associated with an HARQ process configured as HARQ feedback disabling, although unnecessary, still occupies a subframe. For example, in the example of FIG. 6, the feedbacks transmitted in subframes #14 and 15 are unnecessary. It is desirable that they are not transmitted.

According to a second embodiment, for IoT NIN HARQ bundling with HARQ disabling, each HARQ bundle only includes TBs each of which is associated with an HARQ process configured with HARQ feedback enabling. In addition, the “TBs in bundle” field of the DCI, which indicates the cumulative number of TBs in an HARQ bundle, will only consider the TBs each of which is associated with an HARQ process configured with HARQ feedback enabling. In other words, according to the second embodiment, the “TBs in bundle” field of the DCI indicates the cumulative number of TBs in an HARQ bundle, each of which is associated with an HARQ process configured with HARQ feedback enabling, in an HARQ bundle.

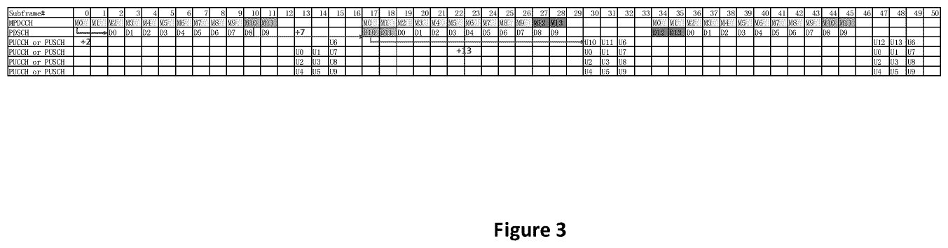

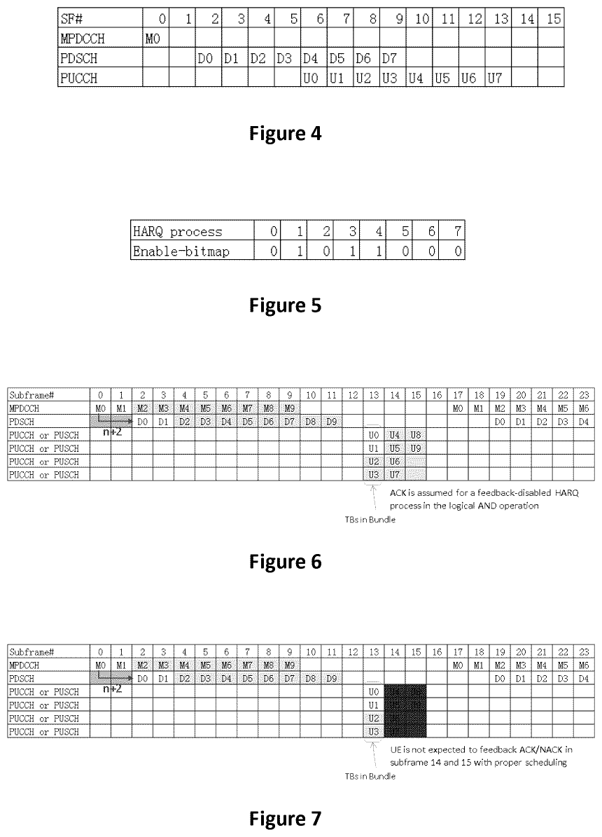

The maximal PDSCH number restriction (i.e. the number of PDSCHs that requires HARQ feedback) in a bundle circle (i.e. data bundle) is determined by the number of HARQ processes configured with HARQ feedback enabling (e.g. min (total number of HARQ processes configured with HARQ process enabling, 12)) that is semi-statically configured by higher layer. In particular, if data scheduling across bundle circles is not supported (e.g. as shown in FIG. 2), the maximal PDSCH number restriction in a bundle circle is determined by (e.g. equal to) the number of HARQ processes configured with HARQ feedback enabling. If data scheduling across bundle circles is supported (e.g. as shown in FIG. 3), the maximal PDSCH number restriction in a bundle circle is determined by (e.g. equal to) a minimal value of 12 and the total number of HARQ processes configured with HARQ process enabling.

For example, in the example of FIG. 7, the HARQenabledisableConfiguration for D0 to D9 is configured as {1100000000}, where ‘I’ indicates enable and ‘0’ indicates disable, i.e. each of D0 and D1 is associated with an HARQ process configured with HARQ feedback enabling, and each of D2 to D9 is associated with an HARQ process configured with HARQ feedback disabling. So, the maximal PDSCH number restriction is 2 (i.e. equal to the number of HARQ processes configured with HARQ feedback enabling). It means that the maximal PDSCH number restriction limits the number of received PDSCHs that need HARQ feedback, while the received PDSCHs that do not need HARQ feedback (i.e. associated with an HARQ process configured with HARQ feedback disabling) is not subject to the maximal PDSCH number restriction.

The restriction of the maximal number of uplink subframes for feedback in a bundle circle (i.e. data bundle) is determined by the number of HARQ processes configured with HARQ feedback enabling and the maximal bundle size (e.g. 4), and in particular, determined by ceil (the number of HARQ processes configured with HARQ feedback enabling/the maximal bundle size). In the example of FIG. 7, if the maximal bundle size is 4, the restriction of the maximal number of uplink subframes for feedback in a bundle circle (i.e. data bundle) is ceil (2/4)=1.

The restriction of the maximal number of uplink subframes for feedback in a bundle circle is determined by the number of HARQ processes configured with HARQ feedback enabling and the maximal bundle size. So, the maximal number of uplink subframes for feedback in a bundle circle can be 1 or 2 or 3. It implies that the scheduling delay between DCI and PDSCH, which is 7 subframes considering the uplink subframes for feedback that are fixed as 3 in the prior art, will not always be 7 subframes, but can be 5 or 6 subframes.

So, the scheduling delay between DCI and the corresponding PDSCH is updated as Table 5. In Table 5, S stands for the maximal number of uplink subframes for feedback in a bundle circle. S can be for example, 1 or 2 or 3, depending on the number of HARQ processes configured with HARQ feedback enabling (in a bundle circle) and the maximal bundle size.

TABLE 5

| Option | Description |
|---|---|
| 0 | 2 BL/CE DL subframes |
| 1 | 1 BL/CE DL subframe + 1 subframe + S BL/CE UL |
| | subframes + 1 subframe + 1 BL/CE DL subframe |
| 2 | 1 subframe + S BL/CE UL subframes + 1 subframe + 2 |
| | BL/CE DL subframes |

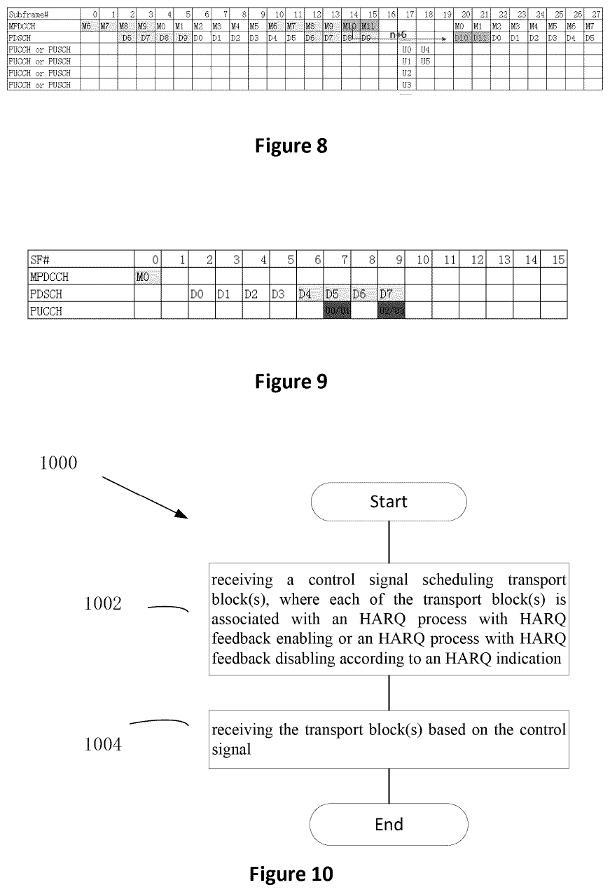

For example, in the example of FIG. 8, the maximal number of uplink subframes for feedback in a bundle circle (i.e. S) is 2. The scheduling delay of DCI (M10) is Option 1:1 BL/CE DL subframe (subframe #15)+1 subframe (subframe #16)+S(=2) BL/CE UL subframes (subframes #17 and 18)+1 subframe (subframe #19)+1 BL/CE DL subframe (subframe #20). The scheduling delay of DCI (M11) is Option 2:1 subframe (subframe #16)+S(=2) BL/CE UL subframes (subframes #17 and 18)+1 subframe (subframe #19)+2 BL/CE DL subframes (subframes #20 and 21).

As a whole, according to the second embodiment, for HARQ-ACK transmission in subframe n (e.g. subframe #17 in FIG. 8), the UE shall generate one HARQ-ACK bit by performing a logical AND operation of HARQ-ACKs across all 1≤M≤4 BL/CE DL DL subframes (e.g. D0-D3 in subframes #6 to 9) for which provides a transport block for a HARQ process with enabled HARQ-ACK information and subframe n is the ‘HARQ-ACK transmission subframe’.

If the UE has received W (e.g. W=12) PDSCH transmissions before subframe n (e.g. any subframe between the subframes in which PDSCH is received and the subframes in which feedback is transmitted, for example, subframe #16 in FIG. 8), and if the UE is expected to transmit HARQ-ACK for the W PDSCH transmissions in subframes {n₁ . . . , n_{L}}, nᵢ≥n (n₁=17 and n₂=18), the UE is not expected to receive a new PDSCH transmission in subframe n, W is determined by the number of enabled HARQ process configured by higher layer parameter.

If the UE is expected to transmit HARQ-ACK for the PDSCH transmissions received before subframe n in subframes {n₁, n₂ . . . n_{M}}, nᵢ≥n, the UE is not expected to receive a new PDSCH transmission in subframe n for which the HARQ-ACK is to be transmitted in subframe n_{S+1}∈{n₁, n₂ . . . n_{S}}, S=┌W/4┐ where ┌x┐ is the ceil function of x.

According to a third embodiment, for multiple TB scheduling, the TBs belonging to a TB bundle are only TBs each of which is associated with a HARQ process configured with feedback enabling. In addition, the “Multi-TB HARQ-ACK bundling size” field of the DCI, which indicates the bundle size (e.g. number of TBs in a TB bundle or the number of bundle), the HARQ-ACK bundling will only consider the TBs associated with an HARQ process configured with HARQ feedback enabling. In other words, according to the second embodiment, the “Multi-TB HARQ-ACK bundling size” field of the DCI indicates the bundle size. TB(s) associated with an HARQ process configured with HARQ feedback enabling are included in a TB bundle.

For each TB among TB₀, TB₁, . . . TBᵢ . . . , TB_{N}_{_{TB}}₋₁ where N_{TB} is the number of scheduled TBs determined in the corresponding DCI, the TBs each of which is associated with a HARQ process configured with feedback enabling are extracted (which means that the TBs each of which is associated with a HARQ process configured with feedback disabling are excluded) to form TB/(o), TB_{f(1)}, . . . . TB_{f(m-1)}. It means that each TB_{f(i)} (i=0 to m) is a transport block associated with a HARQ process configured with feedback enabling.

For example, the following code can be used for extracting all TBs each of which is associated with a HARQ process configured with feedback enabling from the scheduled N_{TB} TBs:

```
Set m =0
or i=0,1,..., N_{TB} − 1
  if TBᵢ for a HARQ process is associated with HARQ feedback enabling
    m=m+1;
    f(m) = i;
  endif
endfor
```

According to the third embodiment, the UE shall generate M HARQ-ACK bits by performing a logical AND operation of HARQ-ACKs across all TBs in each TB bundle A_{b} where b=1, . . . , M. The set of TBs that belong to TB bundle A_{b} and the number of TB bundles M are given by Table 5.

TABLE 5

| DCI field | | | | | |
|---|---|---|---|---|---|
| ‘Multi-TB | | | | | |
| HARQ-ACK | | | | | |
| bundling size’ | m = 1 | m = 2 | m = 4 | m = 6 | m = 8 |
| 00 | A₁ = {TB_{f(0)}} | A₁ = {TB_{f(0)}} | A₁ = {TB_{f(0)}} | A₁ = {TB_{f(0)}} | A₁ = {TB_{f(0)}} |
| | | A₂ = {TB_{f(1)}} | A₂ = {TB_{f(1)}} | A₂ = {TB_{f(1)}} | A₂ = {TB_{f(1)}} |
| | | | A₃ = {TB_{f(2)}} | A₃ = {TB_{f(2)}} | A₃ = {TB_{f(2)}} |
| | | | A₄ = {TB_{f(3)}} | A₄ = {TB_{f(3)}} | A₄ = {TB_{f(3)}} |
| | | | | A₅ = {TB_{f(4)}} | A₅ = {TB_{f(4)}} |
| | | | | A₆ = {TB_{f(5)}} | A₆ = {TB_{f(5)}} |
| | | | | | A₇ = {TB_{f(6)}} |
| | | | | | A₈ = {TB_{f(7)}} |
| 01 | — | A₁ = {TB_{f(0)}, | A₁ = {TB_{f(0)}, TB_{f(1)}} | A₁ = {TB_{f(0)}, TB_{f(1)}} | A₁ = {TB_{f(0)}, TB_{f(1)}} |
| | | TB_{f(1)}} | A₂ = {TB_{f(2)}, TB_{f(3)}} | A₂ = {TB_{f(2)}, TB_{f(3)}} | A₂ = {TB_{f(2)}, TB_{f(3)}} |
| | | | | A₃ = {TB_{f(4)}, TB_{f(5)}} | A₃ = {TB_{f(4)}, TB_{f(5)}} |
| | | | | | A₄ = {TB_{f(6)}, TB_{f(7)}} |
| 10 | — | — | A₁ = {TB_{f(0)}, TB_{f(1)}} | A₁ = {TB_{f(0)}, TB_{f(1)}, | A₁ = {TB_{f(0)}, TB_{f(1)}, |
| | | | A₂ = {TB_{f(2)}} | TB_{f(2)} } | TB_{f(2)} } |
| | | | A₃ = {TB_{f(3)}} | A₂ = {TB_{f(3)}, TB_{f(4)}, | A₂ = {TB_{f(3)}, TB_{f(4)}, |
| | | | | TB_{f(5)} } | TB_{f(5)}} |
| | | | | | A₃ = {TB_{f(6)}, TB_{f(7)} } |
| 11 | — | — | A₁ = {TB_{f(0)}, TB_{f(1)}, | A₁ = {TB_{f(0)}, TB_{f(1)}, | A₁ = {TB_{f(0)}, TB_{f(1)}, |
| | | | TB_{f(2)}, TB_{f(3)} } | TB_{f(2)}, TB_{f(3)} } | TB_{f(2)}, TB_{f(3)} } |
| | | | | A₂ = {TB_{f(4)}, TB_{f(5)} } | A₂ = {TB_{f(4)}, TB_{f(5)}, |
| | | | | | TB_{f(6)}, TB_{f(7)} } |

The value of m is the number of scheduled TBs each of which is associated with a HARQ process configured with feedback enabling. Since Table 5 only provides candidate values of 1, 2, 4, 6 and 8 for m, the base unit (e.g. gNB) shall ensure that the value of m (i.e. the number of scheduled TBs each of which is associated with a HARQ process configured with feedback enabling) shall be one of 1, 2, 4, 6 and 8.

For example, as shown in FIG. 9, N_{TB} is 8 and TB₀, TB₃, . . . , TB₇ are scheduled to be transmitted in subframes #2 to 9 (denoted as D0 to D7). If each of TB₀, TB₁, TB₂, and TBs is associated with HARQ process configured with feedback enabling, and each of TB₄, TB₅, TB₆, and TB₇ is associated with HARQ process configured with feedback disabling, then m=4 (i.e. 4 TBs (TB₀, TB₁, TB₂, and TB₃) are associated with HARQ process configured with feedback enabling) and TB_{f(0)}, TB_{f(1)}, . . . . TB_{f(3)} can be included in TB bundle(s). It means that HARQ feedback is necessary for the 4 TBs (TB₀, TB₁, TB₂, and TB₃) associated with HARQ process configured with feedback enabling. Suppose the DCI field ‘Multi-TB HARQ-ACK bundling size’ is ‘01’, then there are two TB bundles: A₁={TB_{f(0)}, TB_{f(1)}}, and A₂={TB_{f(2)}, TB_{f(3)}} according to Table 5 (m=4). A₁={TB_{f(0)}TB_{f(1)}}={TB_{f(0)}, TB_{f(1)}}. A₂={TB_{f(2)}, TB_{f(3)}}={TB₂, TB₃}. So, the HARQ-ACK bit (labelled as U0/U1 in FIG. 9) used for the feedback of TB bundle A₁ can be determined by a logical AND operation of the HARQ-ACK of each TB (e.g. TB₀, TB₁) belonging to the TB bundle A₁; and the HARQ-ACK bit (labelled as U2/U3 in FIG. 9) used for the feedback of TB bundle A₂ can be determined by a logical AND operation of the HARQ-ACK of each TB (e.g. TB₂, TB₃) belonging to the TB bundle A₂.

FIG. 10 is a schematic flow chart diagram illustrating an embodiment of a method 1000 according to the present application. In some embodiments, the method 1000 is performed by an apparatus, such as a remote unit (UE). In certain embodiments, the method 1000 may be performed by a processor executing program code, for example, a microcontroller, a microprocessor, a CPU, a GPU, an auxiliary processing unit, a FPGA, or the like.

The method 1000 may comprise 1002 receiving a control signal scheduling transport block(s), where each of the transport block(s) is associated with an HARQ process with HARQ feedback enabling or an HARQ process with HARQ feedback disabling according to an HARQ indication; and 1004 receiving the transport block(s) based on the control signal.

In some embodiment, the HARQ indication is configured by higher layer parameter or indicated by the control signal.

In some embodiment, the method further comprises generating, a HARQ-ACK bit by performing logical AND operation of HARQ-ACKs across a first number of time slots, wherein, each of the first number of time slots provides a transport block associated with an HARQ process with HARQ feedback enabling; and transmitting the HARQ-ACK bit in a first time slot, wherein, the first time slot is the HARQ-ACK feedback time slot for the transport block in each of first number of time slot.

In some embodiment, the method further comprises after having received a second number of transport blocks before a second time slot, transmitting feedback for the second number of transport blocks no earlier than the second time slot, and not expected to receive new transport block in the second time slot. The second number may be determined by the number of HARQ processes with HARQ feedback enabling indicated by the HARQ indication. Alternatively, the second number is determined by a minimal value of the number of HARQ processes with HARQ feedback enabling indicated by the HARQ indication and a fixed value.

In some embodiment, the method further comprises: after having received transport blocks before a third time slot, transmitting feedback for the received transport blocks within a time slot set, wherein, the time slot set includes a third number of time slots determined by at least one of the number of HARQ processes with HARQ feedback enabling and a maximal bundle size, and each time slot in the time slot set is not earlier than the third time slot, and not expected to receive new transport block in the third time slot, the feedback for which is in a time slot not within time slot set. A scheduling delay between the control signal and the transmission of the transport block may be determined by the third number.

In some embodiment, the control signal schedules multiple transport blocks, and the method further comprises: extracting, from the multiple transport blocks, a first set of transport blocks with a fourth number of transport blocks, and each transport block of the first set is associated with an HARQ process number with HARQ feedback enabling. The method may further comprise: dividing the first set of transport blocks into TB bundles according to the control signal and the fourth number; generating a HARQ-ACK bit for each TB bundle by performing logical AND operation of HARQ-ACK(s) of TB(s) included in each TB bundle; and transmitting the generated HARQ-ACK bit(s) for the first set of transport blocks.

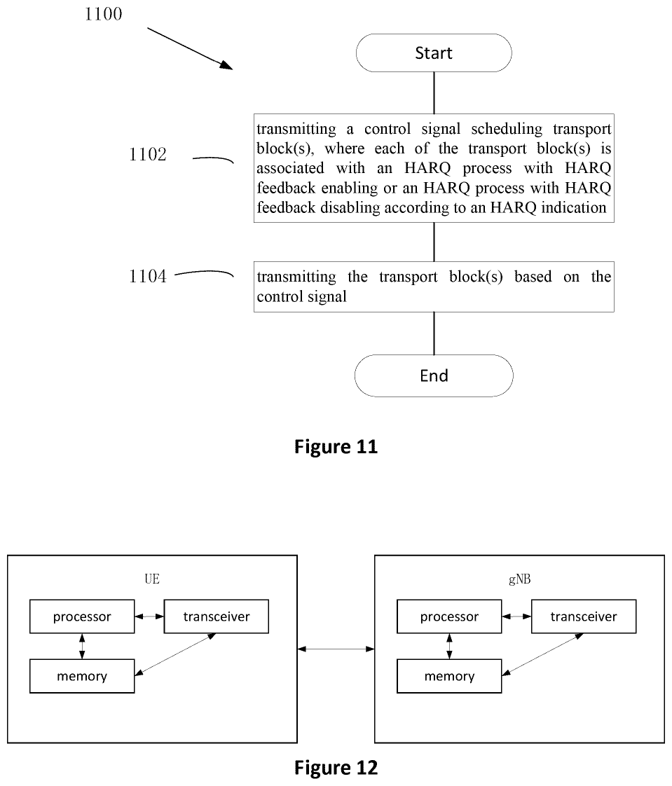

FIG. 11 is a schematic flow chart diagram illustrating a further embodiment of a method 1100 according to the present application. In some embodiments, the method 1100 is performed by an apparatus, such as a base unit. In certain embodiments, the method 1100 may be performed by a processor executing program code, for example, a microcontroller, a microprocessor, a CPU, a GPU, an auxiliary processing unit, a FPGA, or the like.

The method 1100 may comprise 1102 transmitting a control signal scheduling transport block(s), where each of the transport block(s) is associated with an HARQ process with HARQ feedback enabling or an HARQ process with HARQ feedback disabling according to an HARQ indication; 1104 transmitting the transport block(s) based on the control signal.

In some embodiment, the HARQ indication is configured by higher layer parameter or indicated by the control signal.

In some embodiment, the method further comprises: receiving a HARQ-ACK bit in a first time slot, wherein the HARQ-ACK bit is generated by performing logical AND operation of HARQ-ACKs across a first number of time slots, wherein, each of the first number of time slots provides a transport block associated with an HARQ process with HARQ feedback enabling, and the first time slot is the HARQ-ACK feedback time slot for the transport block in each of first number of time slot.

In some embodiment, the method further comprises: after having transmitted a second number of transport blocks before a second time slot, receiving feedback for the second number of transport blocks no earlier than the second time slot. The second number may be determined by the number of HARQ processes with HARQ feedback enabling indicated by the HARQ indication. Alternatively, the second number may be determined by a minimal value of the number of HARQ processes with HARQ feedback enabling indicated by the HARQ indication and a fixed value.

In some embodiment, the method further comprises: after having transmitted transport blocks before a third time slot, receiving feedback for the received transport blocks within a time slot set, wherein, the time slot set includes a third number of time slots determined by at least one of the number of HARQ processes with HARQ feedback enabling and a maximal bundle size, and each time slot in the time slot set is not earlier than the third time slot. A scheduling delay between the control signal and the transmission of the transport block is determined by the third number.

In some embodiment, the control signal schedules multiple transport blocks. The method may further comprise receiving HARQ-ACK bit(s) for a first set of transport blocks, wherein, the first set of transport blocks are extracted from the multiple transport blocks and have a fourth number of transport blocks, each transport block of the first set is associated with an HARQ process number with HARQ feedback enabling, the first set of transport blocks are divided into TB bundles according to the control signal and the fourth number, a HARQ-ACK bit for each TB bundle is generated by performing logical AND operation of HARQ-ACK(s) of TB(s) included in each TB bundle.

FIG. 12 is a schematic block diagram illustrating apparatuses according to one embodiment.

Referring to FIG. 12, the UE (i.e. the remote unit) includes a processor, a memory, and a transceiver. The processor implements a function, a process, and/or a method which are proposed in FIG. 10.

The UE comprises a processor; and a transceiver coupled to the processor, wherein the processor is configured to receive, via the transceiver, a control signal scheduling transport block(s), where each of the transport block(s) is associated with an HARQ process with HARQ feedback enabling or an HARQ process with HARQ feedback disabling according to an HARQ indication; and receive, via the transceiver, the transport block(s) based on the control signal.

In some embodiment, the HARQ indication is configured by higher layer parameter or indicated by the control signal.

In some embodiment, the processor is further configured to generate, a HARQ-ACK bit by performing logical AND operation of HARQ-ACKs across a first number of time slots, wherein, each of the first number of time slots provides a transport block associated with an HARQ process with HARQ feedback enabling; and transmit, via the transceiver, the HARQ-ACK bit in a first time slot, wherein, the first time slot is the HARQ-ACK feedback time slot for the transport block in each of first number of time slot.

In some embodiment, the processor is further configured to after having received a second number of transport blocks before a second time slot, transmit, via the transceiver, feedback for the second number of transport blocks no earlier than the second time slot, and not expected to receive new transport block in the second time slot. The second number may be determined by the number of HARQ processes with HARQ feedback enabling indicated by the HARQ indication. Alternatively, the second number may be determined by a minimal value of the number of HARQ processes with HARQ feedback enabling indicated by the HARQ indication and a fixed value.

In some embodiment, the processor is further configured to: after having received transport blocks before a third time slot, transmit, via the transceiver, feedback for the received transport blocks within a time slot set, wherein, the time slot set includes a third number of time slots determined by at least one of the number of HARQ processes with HARQ feedback enabling and a maximal bundle size, and each time slot in the time slot set is not earlier than the third time slot, and not expected to receive new transport block in the third time slot, the feedback for which is in a time slot not within time slot set. A scheduling delay between the control signal and the transmission of the transport block may be determined by the third number.

In some embodiment, the control signal schedules multiple transport blocks, and the processor is further configured to extract, from the multiple transport blocks, a first set of transport blocks with a fourth number of transport blocks, and each transport block of the first set is associated with an HARQ process number with HARQ feedback enabling. The processor may be further configured to: divide the first set of transport blocks into TB bundles according to the control signal and the fourth number; generate a HARQ-ACK bit for each TB bundle by performing logical AND operation of HARQ-ACK(s) of TB(s) included in each TB bundle; and transmit, via the transceiver, the generated HARQ-ACK bit(s) for the first set of transport blocks.

Referring to FIG. 12, the gNB (i.e. base unit) includes a processor, a memory, and a transceiver. The processors implement a function, a process, and/or a method which are proposed in FIG. 11.

The base unit comprises a processor; and a transceiver coupled to the processor, wherein the processor is configured to transmit, via the transceiver, a control signal scheduling transport block(s), where each of the transport block(s) is associated with an HARQ process with HARQ feedback enabling or an HARQ process with HARQ feedback disabling according to an HARQ indication; and transmit, via the transceiver, the transport block(s) based on the control signal.

In some embodiment, the HARQ indication is configured by higher layer parameter or indicated by the control signal.

In some embodiment, the processor is further configured to: receive, via the transceiver, a HARQ-ACK bit in a first time slot, wherein the HARQ-ACK bit is generated by performing logical AND operation of HARQ-ACKs across a first number of time slots, wherein, each of the first number of time slots provides a transport block associated with an HARQ process with HARQ feedback enabling, and the first time slot is the HARQ-ACK feedback time slot for the transport block in each of first number of time slot.

In some embodiment, the processor is further configured to: after having transmitted a second number of transport blocks before a second time slot, receive, via the transceiver, feedback for the second number of transport blocks no earlier than the second time slot. The second number may be determined by the number of HARQ processes with HARQ feedback enabling indicated by the HARQ indication. Alternatively, the second number may be determined by a minimal value of the number of HARQ processes with HARQ feedback enabling indicated by the HARQ indication and a fixed value.

In some embodiment, the processor is further configured to: after having transmitted transport blocks before a third time slot, receive, via the transceiver, feedback for the received transport blocks within a time slot set, wherein, the time slot set includes a third number of time slots determined by at least one of the number of HARQ processes with HARQ feedback enabling and a maximal bundle size, and each time slot in the time slot set is not earlier than the third time slot. A scheduling delay between the control signal and the transmission of the transport block is determined by the third number.

In some embodiment, the control signal schedules multiple transport blocks. The processor may be further configured to receive, via the transceiver, HARQ-ACK bit(s) for a first set of transport blocks, wherein, the first set of transport blocks are extracted from the multiple transport blocks and have a fourth number of transport blocks, each transport block of the first set is associated with an HARQ process number with HARQ feedback enabling, the first set of transport blocks are divided into TB bundles according to the control signal and the fourth number, a HARQ-ACK bit for each TB bundle is generated by performing logical AND operation of HARQ-ACK(s) of TB(s) included in each TB bundle.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one processor and configured to cause the UE to:
receive a control signal scheduling transport blocks, wherein each of the transport blocks is associated with a hybrid automatic repeat request (HARQ) process with HARQ feedback enabling or is associated with a HARQ process with HARQ feedback disabling according to a HARQ indication; and
receive the transport blocks based on the control signal.

2. The UE of claim 1, wherein, the HARQ indication is configured by a higher layer parameter or indicated by the control signal.

3. The UE of claim 1, wherein, the at least one processor is further configured to cause the UE to:
generate a HARQ-ACK bit by performing a logical AND operation of HARQ-ACKs across a first number of time slots, wherein, each of the first number of time slots provides a transport block associated with an HARQ process with HARQ feedback enabling; and
transmit the HARQ-ACK bit in a first time slot, wherein, the first time slot is the HARQ-ACK feedback time slot for the transport block in each of the first number of time slots.

4. The UE of claim 1, wherein, the at least one processor is further configured to cause the UE to:
receive a second number of transport blocks before a second time slot;
transmit feedback for the second number of transport blocks no earlier than the second time slot, and
not expect to receive a new transport block in the second time slot.

5. The UE of claim 4, wherein,
the second number is determined by the number of HARQ processes with HARQ feedback enabling.

6. The UE of claim 4, wherein,
the second number is determined by a minimal value of the number of HARQ processes with HARQ feedback enabling indicated by a fixed value.

7. The UE of claim 1, wherein, the at least one processor is further configured to cause the UE to:
receive transport blocks before a third time slot;
transmit feedback for the received transport blocks within a time slot set,
wherein, the time slot set includes a third number of time slots determined by at least one of the number of HARQ processes with HARQ feedback enabling and a maximal bundle size, and each time slot in the time slot set is not earlier than the third time slot, and
not expect to receive a new transport block in the third time slot, wherein the feedback is in a time slot not within the time slot set.

8. The UE of claim 7, wherein, the third number determines a scheduling delay between the control signal and the transmission of the transport block.

9. The UE of claim 1, wherein,
When the control signal schedules multiple transport blocks,
the at least one processor is further configured to cause the UE to: extract, from the multiple transport blocks, a first set of transport blocks with a fourth number of transport blocks, and each transport block of the first set is associated with HARQ process number with HARQ feedback enabling.

10. The UE of claim 9, wherein, the at least one processor is further configured to cause the UE to:
divide the first set of transport blocks into TB (transport block) bundles according to the control signal and the fourth number;
generate a HARQ-ACK bit for each TB bundle by performing a logical AND operation of HARQ-ACKs of TBs included in each TB bundle; and
transmit the generated HARQ-ACK bits for the first set of transport blocks.

11. A method performed by a user equipment (UE), the method comprising:
receiving a control signal scheduling transport blocks, wherein each transport block is associated with a hybrid automatic repeat request (HARQ) process with HARQ feedback enabling or is associated with a HARQ process with HARQ feedback disabling according to a HARQ indication; and
receiving the transport blocks based on the control signal.

12. A base unit, comprising:
at least one memory; and
at least one processor coupled with the at least one memory and configured to cause the base unit to:
transmit a control signal scheduling transport blocks wherein each transport block is associated with a hybrid automatic repeat request (HARQ) process with HARQ feedback enabling or is associated with a HARQ process with HARQ feedback disabling according to a HARQ indication; and
transmit the transport blocks based on the control signal.

13. The base unit of claim 12, wherein,
the at least one processor is further configured to cause the base unit to:
receive a HARQ-ACK bit in a first time slot, wherein the HARQ-ACK bit is generated by performing a logical AND operation of HARQ-ACKs across a first number of time slots, wherein, each of the first number of time slots provides a transport block associated with a HARQ process with HARQ feedback enabling, and the first time slot is the HARQ-ACK feedback time slot for the transport block in each of the first number of time slots.

14. The base unit of claim 12, wherein, the at least one processor is further configured to cause the base unit to:
transmit a second number of transport blocks before a second time slot; and
receive feedback for the second number of transport blocks no earlier than the second time slot.

15. The base unit of claim 12, wherein, the at least one processor is further configured to cause the base unit to:
transmit transport blocks before a third time slot; and
receive feedback for the received transport blocks within a time slot set,
wherein, the time slot set includes a third number of time slots determined by at least one of the number of HARQ processes with HARQ feedback enabling and a maximal bundle size, and each time slot in the time slot set is not earlier than the third time slot.

16. A processor for wireless communication, comprising:
at least one controller coupled with at least one memory and configured to cause the processor to:
receive a control signal scheduling transport blocks,
wherein each of the transport blocks is associated with a hybrid automatic repeat request (HARQ) process with HARQ feedback enabling or is associated with a HARQ process with HARQ feedback disabling according to a HARQ indication; and
receive the transport blocks based on the control signal.

17. The processor of claim 16, wherein the HARQ indication is configured by a higher layer parameter or indicated by the control signal.

18. The processor of claim 16, wherein the at least one controller is further configured to cause the processor to:
generate a HARQ-ACK bit by performing a logical AND operation of HARQ-ACKs across a first number of time slots,
wherein each of the first number of time slots provides a transport block associated with an HARQ process with HARQ feedback enabling; and
transmit the HARQ-ACK bit in a first time slot,
wherein the first time slot is the HARQ-ACK feedback time slot for the transport block in each of the first number of time slots.

19. The processor of claim 16, wherein the at least one controller is further configured to cause the processor to:
receive a second number of transport blocks before a second time slot;
transmit feedback for the second number of transport blocks no earlier than the second time slot, and
not expect to receive a new transport block in the second time slot.

20. The processor of claim 19, wherein the second number is determined by the number of HARQ processes with HARQ feedback enabling or by a minimal value of the number of HARQ processes with HARQ feedback enabling indicated by a fixed value.
